(19) United States
(12) Patent Application Publication
(10) Pub. No.: US 2005/0067254 A1
(43) Pub. Date: Mar. 31, 2005

(54) Flipper arm ejector

(76) Inventors: Robert G. Jones, Darmouth (CA); Peter G. Jones, Musquodoboit Harbour (CA)

Correspondence Address: SPENCER, FANE, BRITT & BROWNE, 1000 WALNUT STREET, SUITE 1400, KANSAS CITY, MO, 64106-2140, US

(21) Appl. No.: 10/676,348

(22) Filed: Sep. 30, 2003

(51) Int. Cl. B65G 47/10

(52) U.S. Cl. 198/370.07

(57) ABSTRACT

Apparatuses and methods for deflecting a product from a distribution conveyor of a product determination and separation line are provided. Ejectors are positioned along a conveyor and are selectively activated and deactivated to result in deflection of product from the conveyor into a desired bin or other storage location. A flipper arm of the ejector is positioned to at least partially overlap the surface of the conveyor belt to reduce wear and ravel of the conveyor belt. An actuator which rotates the flipper arm is positioned above the conveyor to allow for easy cleaning and maintenance. The ejector is releasably and pivotally connected to the frame of the conveyor to allow for further ease of cleaning and maintenance.

### FIELD OF THE INVENTION

The present invention relates to methods and apparatuses for deflecting a product from a distribution conveyor of a product determination and separation line.

### BACKGROUND OF THE INVENTION

In food processing facilities, it is typically necessary to select a single article/object or food item from a bulk load of such food items and to grade, or weigh or measure some attribute of the food item. This is done for purposes of pricing the food item or for meeting particular specifications related to the food item. Once the attribute for the food item has been determined, it is then often necessary to place the food item into a segregated location along with a group of other food items having the same or similar attribute(s). Generally, apparatuses and methods for determining attributes of food items require that a single food item be removed from the bulk load at a first location, placed on a conveyor at a second location, and then moved via the conveyor to a device for measuring the attribute. The food item is then removed from the conveyor through the use of a flipper arm ejector (deflection arm) that deflects the item into a holding bin or other receptacle.

FIG. 2 shows a prior art flipper arm ejector as it would be located in a common item attribute determination and separation process line. Flipper/deflection arm ejector 42 includes flipper 43 mounted to support shaft 45 above the top surface of conveyor belt 41. Support shaft 45 extends downward from flipper 43 and is mounted to frame 49 of distribution conveyor 40 via a rotatable bearing (not shown) attached to the inner wall of conveyor frame 49 at location 44. Support shaft 45 is connected to piston 46 via linkage 48. Piston 46 is mounted to the conveyor frame via bracket 47. The rotatable bearing, linkage 48 and piston 46 are all located below conveyor belt 41 and within frame 49 of distribution conveyor 40. In operation, piston 46 extends and retracts laterally causing lateral displacement of linkage 48 at connection point 51. Linkage 48 is rigidly connected to shaft 45 at connection point 52. Shaft 45 is mounted to only be capable of rotational motion, and not lateral motion. Thus, as connection point 51 is displaced laterally via extension and retraction of piston 46, connection point 52 will not move laterally, resulting in rotation of shaft 45 by linkage 48. Rotation of shaft 45 will result in rotation of flipper 43.

In operation of the portion of the process line shown in FIG. 2, a food item will travel via conveyor belt 41 generally from the direction of end 60 of distribution conveyor 40. As the food item reaches the location of the deflection arm 42 that will deposit the food item in the desired location based upon particular attributes of the food item, piston 46 will be retracted ultimately causing flipper 43 to rotate clockwise so that flipper 43 extends across conveyor belt 41 into an activated position. As the product reaches flipper 43 it will be deflected off of conveyor belt 41 into a bin or other collection area. The direction in which the food item is deflected from conveyor belt 41 will depend up the angle of flipper 43 with respect to the direction of travel of conveyor belt 41. In normal operation flipper 43 will be angled such that the forward motion of conveyor belt 41 urges the food item toward the side of distribution conveyor 40 upon which deflection arm 42 is mounted. In this manner, as the food item contacts flipper 43, piston 46 can be extended resulting in counter-clockwise rotation of flipper 43. This counter-clockwise rotation of flipper 43 will assist in scooping the food item off of conveyor belt 41.

The prior art ejector assembly discussed above with respect to FIG. 2 has several undesirable disadvantages. First the location of piston 46, linkage 48, and the rotatable bearing below the surface of conveyor belt 41 and within frame 49 of distribution conveyor 40, makes replacement of worn or damaged parts extremely difficult. Furthermore, the inclusion of multiple moving parts (i.e. piston 46, linkage 48, shaft 45, bearings, etc.) increases the total number of parts that are subject to wear, which increases the amount of maintenance on the assembly. Therefore, it is desirable to provide an ejector assembly that is easy to service and which has fewer moving parts to wear out.

Another disadvantage is caused by the extension of shaft 45 from below conveyor belt 41 upward to flipper arm 43 located above conveyor belt 41, which results in flipper arm 43 being located above yet to the side of the surface of conveyor belt 41 rather than directly above and overlapping with the conveyor belt surface. Thus, as flipper arm 43 is rotated clockwise from the non-activated position shown in FIG. 2 to an activated position, flipper arm 43 will move from a position at the side of the conveyor belt surface to a position that overlaps the conveyor belt surface. This continuous crossing of the flipper arm 43 from outside the belt surface to inside the belt surface results in premature raveling and wear of conveyor belt 41. Thus, it is desirable to provide a deflection arm assembly that will minimize and/or eliminate the edge wear caused by prior art assemblies.

### SUMMARY OF THE INVENTION

An object of the present invention is to provide apparatuses and methods for deflecting a product from a distribution conveyor of a product determination and separation line. A further object of the present invention is to provide apparatuses and methods for deflecting a product from a distribution conveyor of a product determination and separation line that are easy to service, clean and maintain. Yet another object of the present invention is to provide apparatuses for deflecting a product from a distribution conveyor of a product determination and separation line that have less moving parts and are thus less susceptible to wear than those of the prior art. Another object of the present invention is to provide apparatuses and methods for deflecting a product from a distribution conveyor of a product determination and separation line minimize and/or eliminate the edge wear caused by prior art apparatuses.

In order to overcome the difficulties with the prior art and achieve the above-described objects, the instant invention provides an ejector mounted to the frame of a distribution conveyor. The ejector includes a flipper arm positioned above the conveyor and a rotary actuator connected to the flipper arm. The rotary actuator is positioned above the conveyor to allow for easy access to and maintenance of the assembly. The actuator is mounted to the frame of the conveyor via a two piece support, which includes a first member fixedly attached to the frame and a second member releasably and pivotally attached to the first member. The second member can be released from the first member and pivoted downward from the first member to provide for cleaning and maintenance of the ejector and the conveyor assemblies. In a preferred embodiment of the instant invention, the flipper arm of the ejector is positioned to at least partially overlap the surface of the conveyor belt. This partial overlap eliminates the continuous cross over of the flipper from outside the belt surface to over the belt surface and thus reduces edge wear of the conveyor belt caused by the ejectors of the prior art.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is an elevation view of an attribute measurement and item separation process line that utilizes the apparatuses and methods deflecting objects of the present invention.

FIG. 2 is a perspective view of a portion of an item separation process line incorporating a deflection arm of the prior art.

FIG. 3 is a perspective view of a portion of an item separation process line incorporating deflection arms of the instant invention.

### DESCRIPTION OF A PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

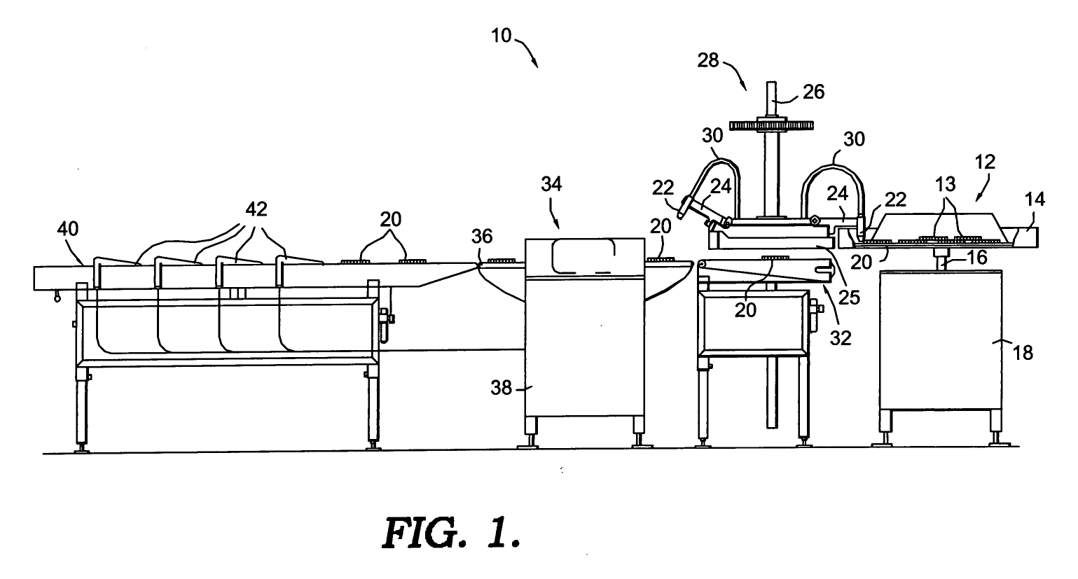

Referring to FIG. 1, a typical product determination and separation process line is shown, which is similar to those disclosed in currently-pending U.S. patent application Ser. No. 10/262,223 to Winkelmolen, incorporated herein by reference. The determination and separation process line shown in FIG. 1 is designed for determination of the weight of an individual product item. In general, weighing and separation process line 10 of FIG. 1 is composed of several different stations through which a product is moved in a manner which accomplishes: (1) acquisition of an individual product item from a group or batch of such products; (2) the delivery of the individual product to a conveyor line in a spaced fashion; (3) the weighing of each individual product; (4) delivery of the individual product to a distribution area; and (5) grouping of the individual product into a bin or holding area with other products having a similar weight.

Still referring to FIG. 1, the weighing and separation process line 10 shown in FIG. 1 now will be more particularly described. In the typical weighing and separation process line 10 shown in FIG. 1, bulk delivery of product 13 is presented to product delivery station 12. Product delivery station 12 is typically provided with turntable 14 operated by drive 16 supported on base 18. Instead of a turntable, product delivery station 12 could be a conveyor or a bin or hopper which provides the bulk items for pick up. Turntable 14 continually moves bulk product 13 to a location on product delivery station 12 where it is accessible by a pickup device which will remove an individual item of bulk product 13 for eventual disposition onto a conveyor where a number of activities may be performed on the product. In the weighing and separation process line 10 shown in FIG. 1, the individual product 20 becomes adhered to vacuum pickup head 22 which is attached to a pickup arm 24. Pickup arm 24 rotates about central shaft 26 of product transfer station 28 and traces a path delineated by cam 25. A low pressure atmosphere is delivered to vacuum pickup head 22 by vacuum line 30. A description of such an article-transfer device having a vacuum pickup and carousel device can be found in U.S. Pat. No. 5,725,082, the specification of which is incorporated herein by reference. By use of the vacuum pickup, products having generally a smooth surface and which are soft and/or variously shaped may be picked up by vacuum head 22 and separated from the bulk product group 13 on turntable 14. Central shaft 26 of product transfer station 28 rotates at a rate such that once vacuum pickup head 22 has extracted an individual product 20 from turntable 14, pickup arm 24 is rotated at a sufficient rate as to deposit product 20 onto takeaway conveyor 32 with a desired spacing between each product 20 so deposited. The proper rotational rate of central shaft 26 of product transfer station 28 is necessary so that as each individual product 20 is deposited onto takeaway conveyor 32, sufficient spacing exists between each individual product 20 so that only a single product 20 is positioned on weighing station 34 at a time. An individual product 20 deposited on takeaway conveyor 32 is delivered to weighing conveyor 36 which moves the individual product 20 across weighing station 34 which is equipped with a load cell (not shown) or other such scale whereupon the individual product 20 is weighed and the weight registered in computer 38 of weighing station 34. After the individual product 20 has been weighed on weighing station 34, and the weight registered in computer 38, individual product 20 is delivered to distribution conveyor 40. Distribution conveyor 40 operates to separate the individual products 20 into a number of categories depending upon the weight of individual product. In the particular line 10 shown in FIG. 1, distribution conveyor 40 has been designed to receive from computer 38 the weight of the individual product 20 determined at weighing station 34 and to deflect individual product 20 into an appropriate holding bin (not shown) based upon the weight of product 20. The deflection of individual product 20 by deflection arm 42 is activated by computer 38 in response to the selection by computer 38 of the particular deflection arm 42 which is associated with the particular bin that contains the weight category of individual product 20. Computer 38 tracks the location of product 20 and activates the appropriate deflection arm 42 for deflection of product 20 as it reaches the deflection arm.

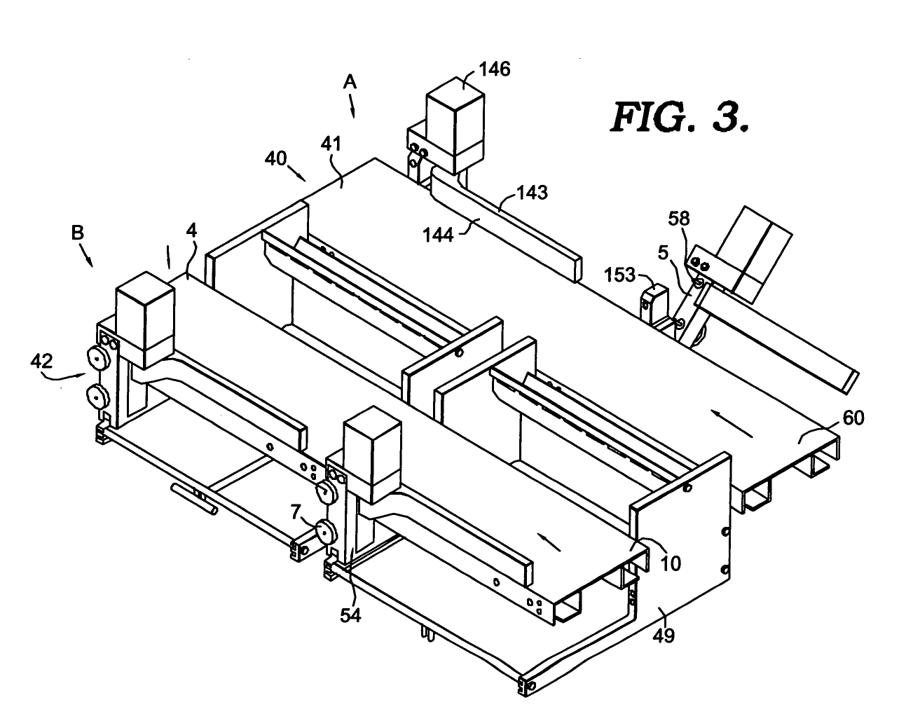

Referring to FIG. 3, a preferred embodiment of the inventive apparatuses and methods for deflecting a product from a distribution conveyor are shown. FIG. 3 shows two distribution conveyors 40, which are each a part of weighing and separation process line 10. Each distribution conveyor 40 shown in FIG. 3 includes two deflection arms (flipper arm ejectors) 42 of the instant invention. Each deflection arm 42 includes a flipper, 143, connected via rotary actuator 146 to support member 154. Flipper 143 is shown in FIG. 3 with rotary actuator in a non-activated state. Flipper 143 is positioned such that inner surface 144 of flipper 143 is located directly over the surface of conveyor belt 41, and that inner surface 144 is generally parallel to the outer edge of conveyor belt 41. In this manner, flipper 143 at least partially overlaps conveyor belt 41 when flipper 143 is in a non-activated position.

Support member 154 includes first member 153 which is fixedly attached to frame 49 of distribution conveyor 40, and second member 155 which is releasably connected to first member 153. The releasable connection between first member 153 and second member 155 comprises threaded screws 158, which extend through second member 155 and thread into a threaded sleeve in first member 153. Knobs 157 are located on the outer end of each of threaded screws 158 to allow an operator to easily screw and/or unscrew threaded screw 158 into the sleeve of first member 153 to selectively attached and/or release second member 155 to/from first member 153. In a preferred embodiment, pivot connection 154 is included between first member 153 and second member 155. Pivot connection 154 supports second member 155 while simultaneously allowing second member 155 to be released from first member 153. This pivotal and releasable connection between first member 153 and second member 155 allows for easy cleaning and maintenance of ejector 42.

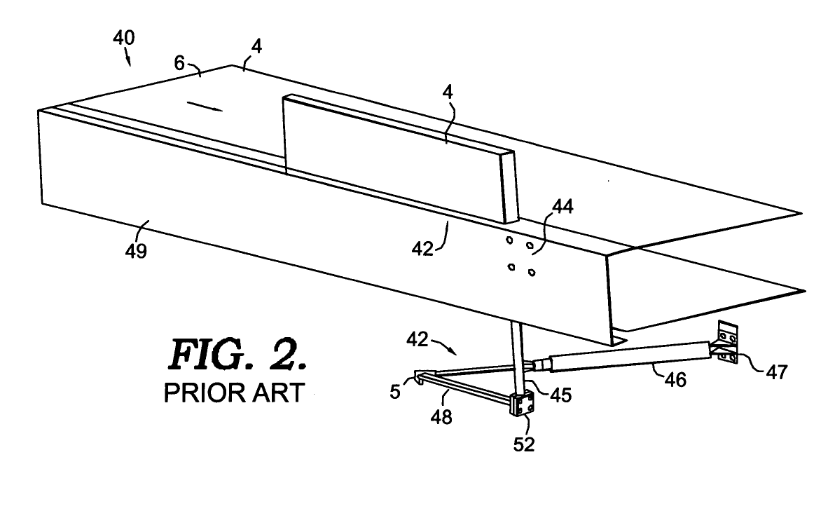

The operation of the portion of process line 10 shown in FIG. 3 functions in similar fashion to that described with respect to the prior art shown in FIG. 2, the primary difference being the components utilized to result in rotation of flipper 143. In operation of the portion of the process line shown in FIG. 3, a food item will travel via conveyor belt 41 generally from the direction of end 60 of distribution conveyor 40. As the food item reaches the location of the deflection arm 42 that will deposit the food item in the desired location based upon particular attributes of the food item, rotary actuator 146 will be activated ultimately causing flipper 143 to rotate so that flipper 143 extends across conveyor belt 41 into an activated position. With respect to flipper arm ejectors 42 located on side A of the portion of process line 10 shown in FIG. 3, activation of rotary actuator 146 will rotate flipper 143 in a clockwise direction. With respect to flipper arm ejectors 42 located on side B of the portion of process line 10 shown in FIG. 3, activation of rotary actuator 146 will rotate flipper 143 in a counter-clockwise direction. As the product reaches flipper 143 it will be deflected off of conveyor belt 41 into a bin or other collection area. The direction in which the food item is deflected from conveyor belt 41 will depend up the angle of flipper 143 with respect to the direction of travel of conveyor belt 41. In normal operation flipper 143 will be angled such that the forward motion of conveyor belt 41 urges the food item toward the side of distribution conveyor 40 upon which flipper arm ejector 42 is mounted. In this manner, as the food item contacts flipper 143, actuator 146 can be deactivated resulting in rotation of flipper 143 back to its original location (counter-clockwise rotation on side A and clockwise rotation on side B). This rotation back to its non-activated location of flipper 143 will assist in scooping the food item off of conveyor belt 41. It will be appreciated that ejectors 42 can be utilized in the manner just describe to essentially “pull” items off of conveyor 41, by deflecting those items to the side of frame 49 upon which the ejector is mounted, or alternatively ejector 42 can push the item by deflection towards the side of frame 49 opposite to that which ejector 42 is mounted.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive apparatus and methods are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. An ejector for use in a product determination and separation line, the line including a conveyor for transfering a product from a first location, said ejector comprising:
a flipper arm;
an actuator for rotating said flipper arm around an axis substantially perpendicular to the conveyor direction; and
a support for locating said flipper arm and said actuator above a surface of the conveyor.

2. The ejector as claimed in claim 1 wherein said flipper arm is configured to at least partially overlap a belt of said conveyor when said flipper arm is in a non-activated position.

3. The ejector as claimed in claim 1 wherein said support comprises a first member being adapted to fixedly attach to a frame of said conveyor and a second member being adapted to attach via a releasable connection to said first member.

4. The ejector as claimed in claim 3 further comprising a pivot connection between said first member and said second member.

5. The ejector as claimed in claim 4 wherein said releasable connection comprises a screw and threads.

6. An ejector for use in a product determination and separation line, the line including a conveyor for transfering a product from a first location, said ejector comprising:
a flipper arm;
an actuator for rotating said flipper arm; and
a support for locating said flipper arm above a surface of the conveyor to at least partially overlap a belt of the conveyor when said flipper arm is in a non-activated position, wherein said flipper arm is positioned below said actuator.

7. The ejector as claimed in claim 6 wherein said support comprises a first member being adapted to fixedly attach to a frame of said conveyor and a second member being adapted to attach via a releasable connection to said first member.

8. The ejector as claimed in claim 7 further comprising a pivot connection between said first member and said second member.

9. The ejector as claimed in claim 8 wherein said releasable connection comprises a screw and threads.

10. The ejector as claimed in claim 6 wherein said actuator is located above the surface of the conveyor.

11. A method of deflecting a product from a conveyor of a product determination and separation line comprising the steps of:
positioning a flipper arm above the conveyor such that said flipper arm at least partially overlaps a belt of the conveyor when said flipper arm is in a non-activated position;
activating said flipper arm such that said flipper arm rotates across the surface of the conveyor belt as a product approaches; and
directing the product to a desired location via said flipper arm.

12. The method as claimed in claim 11 further comprising the step of deactivating said flipper arm.

13. The ejector as claimed in claim 1 wherein said support comprises a first member being adapted to attach to a frame of said conveyor and a second member being adapted to pivotably attach to, and utilize gravity to swing away from, said first member.

14. The ejector as claimed in claim 6 wherein said support comprises a first member being adapted to attach to a frame of said conveyor and a second member being adapted to pivotably attach to, and utilize gravity to swing away from, said first member.

15. An ejector for use in a product determination and separation line, the line including a conveyor for transfering a product from a first location, said ejector comprising:
a flipper arm;
an actuator for rotating said flipper arm; and
a support for locating said flipper arm and said actuator above a surface of the conveyor, wherein said support comprises a first member being adapted to adjustably attach to a frame of said conveyor and a second member being adapted to attach via a releasable connection to said first member.

16. The ejector as claimed in claim 15 wherein said releasable connection is a hinged connection.

17. The ejector as claimed in claim claim 15 wherein said second member is adapted to utilize gravity to swing away from, said first member via said releasable connection.
